(19) United States
(12) Patent Application Publication
(10) Pub. No.: US 2014/0357290 A1
(43) Pub. Date: Dec. 4, 2014

(54) DEVICE LOCALIZATION USING CAMERA AND WIRELESS SIGNAL

(71) Applicants: Michael Grabner, Seattle, WA (US); Ethan Eade, Seattle, WA (US); David Nister, Bellevue, WA (US)

(72) Inventors: Michael Grabner, Seattle, WA (US); Ethan Eade, Seattle, WA (US); David Nister, Bellevue, WA (US)

(21) Appl. No.: 13/907,741

(22) Filed: May 31, 2013

(51) Int. Cl. H04W 64/00

(52) U.S. Cl. CPC H04W 64/00
USPC 455/456.1

(57) ABSTRACT

A source wireless fingerprint is associated with a source image. One or more eligible cataloged wireless fingerprints having a threshold similarity to the source wireless fingerprint are found. Similarly, one or more eligible cataloged images having a threshold similarity to the source image are found. A current location of a device that acquires the source wireless fingerprint and source image is inferred as a chosen cataloged location of a chosen eligible cataloged wireless fingerprint and a chosen eligible cataloged image.

### BACKGROUND

Many applications and technologies benefit from accurately identifying the location and orientation of a device. However, such location and orientation identification can be difficult, especially indoors.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A source wireless fingerprint is associated with a source image. One or more eligible cataloged wireless fingerprints having a threshold similarity to the source wireless fingerprint are found. Similarly, one or more eligible cataloged images having a threshold similarity to the source image are found. A current location of a device that acquires the source wireless fingerprint and source image is inferred as a chosen cataloged location of a chosen eligible cataloged wireless fingerprint and a chosen eligible cataloged image.

### BRIEF DESCRIPTION OF THE DRAWINGS

FIG. 1A shows example cataloged wireless fingerprints measured at different positions.

FIG. 1B shows example cataloged images taken from different positions.

FIG. 2 shows an example source wireless fingerprint and source image from an unknown position.

FIG. 3 is an example method of device localization.

FIG. 4 shows a selection of an eligible wireless fingerprint from the cataloged wireless fingerprints.

FIG. 5 shows selection of an eligible image from the cataloged images.

FIG. 6 shows another example method of device localization.

FIG. 7 shows acquisition of different images at different orientations from the same position.

FIGS. 8A and 8B show acquisition of different images at different orientations.

FIG. 9 schematically shows a computing system in accordance with embodiments of the present disclosure.

### DETAILED DESCRIPTION

The present disclosure is directed to accurate device localization. Historically, most device localization methods have relied exclusively on a single source input to determine the location of a device (e.g., GPS, triangulation, or image analysis). However, a single source of information may not resolve every location ambiguity. For example, methods of device localization that use only image data may not accurately find the location of devices in environments that are visually similar (e.g., different hallways in the same office building) or visually chaotic (e.g., shopping malls). This disclosure outlines accurate device localization using wireless fingerprints in combination with image analysis.

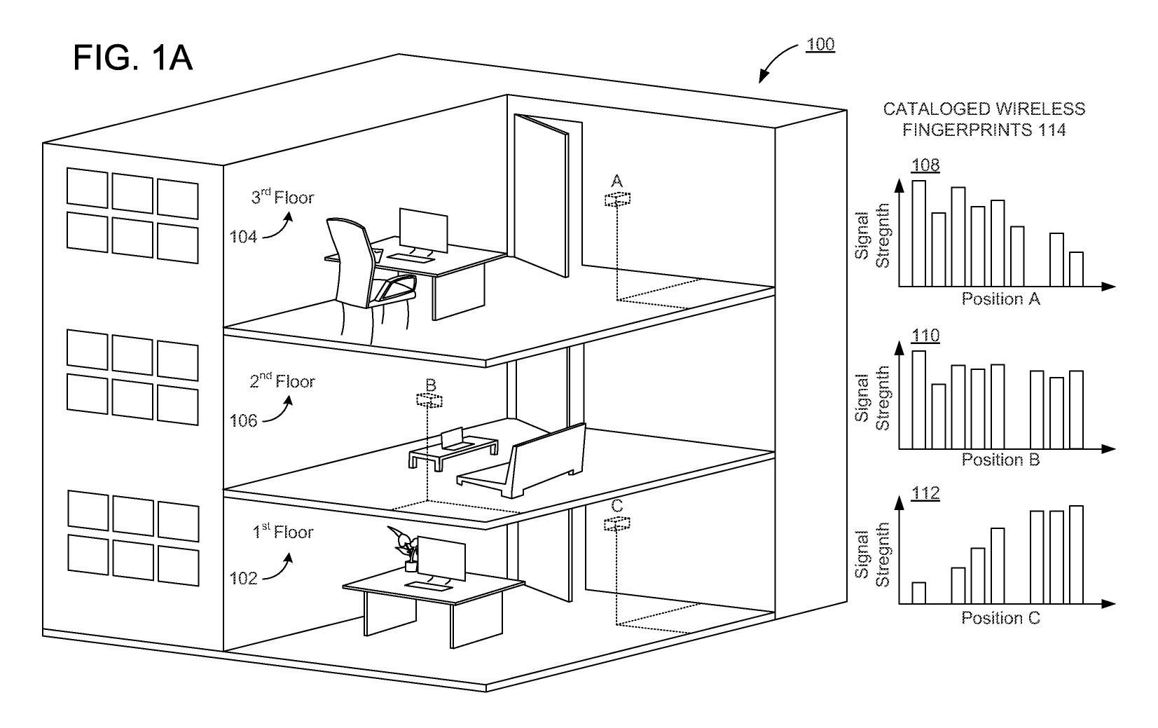

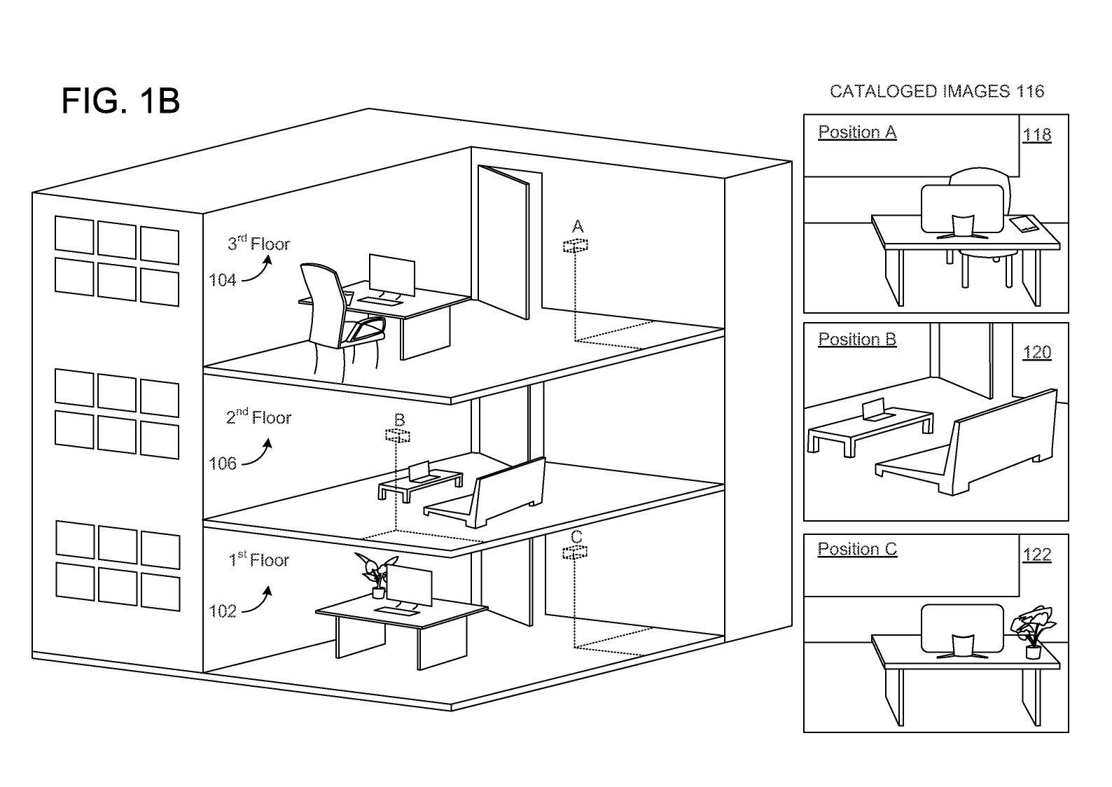

FIG. 1A shows an example environment 100. The example environment includes two rooms (i.e., 1st floor 102 and 3rd floor 104) that are visually similar and one room (i.e., 2nd floor 106) that is visually different. Device localization techniques that rely strictly on image based methods would likely be unable to differentiate between the 1st floor 102 and the 3rd floor 104. To mitigate this issue, each room may be associated with wireless fingerprints that are captured at different positions in the room. As such, position A of the 3rd floor 104 is associated with the wireless fingerprint 108 captured at position A, position B of the 2nd floor 106 is associated with wireless fingerprint 110 captured at position B, and position C of the 1st floor 102 is associated with wireless fingerprint 112 captured at position C. The wireless fingerprints captured at positions A-C are included as cataloged wireless fingerprints 114 in a catalog of locations that may be referenced during device localization.

The wireless fingerprints captured at positions A-C are also associated with images captured at positions A-C. FIG. 1B shows cataloged images 116 captured at the same positions as the wireless fingerprints of FIG. 1A. As shown, position A of the 3rd floor 104 is associated with cataloged image 118 captured at position A, position B of the 2nd floor 106 is associated with cataloged image 120 captured at position B, and position C of the 1st floor 102 is associated with cataloged image 122 captured at position C. The images captured at positions A-C are also included in the cataloged locations as cataloged images 116.

Each cataloged wireless fingerprint is associated with both a cataloged location and a cataloged image and, therefore, each cataloged image is associated with both a cataloged location and a cataloged wireless fingerprint. The correspondence between cataloged images 116 and the cataloged wireless fingerprints 114 is one-to-one (i.e., each image is associated with a specific wireless fingerprint).

An associated cataloged wireless fingerprint, cataloged image, and cataloged location form a location defining package. Although the correspondence between the cataloged wireless fingerprint and the cataloged image is one-to-one, multiple location defining packages may be associated with a single location or room. For example, the 3rd Floor of FIGS. 1A and 1B may be defined by multiple location defining packages that include images and wireless fingerprints captured at multiple positions within the room.

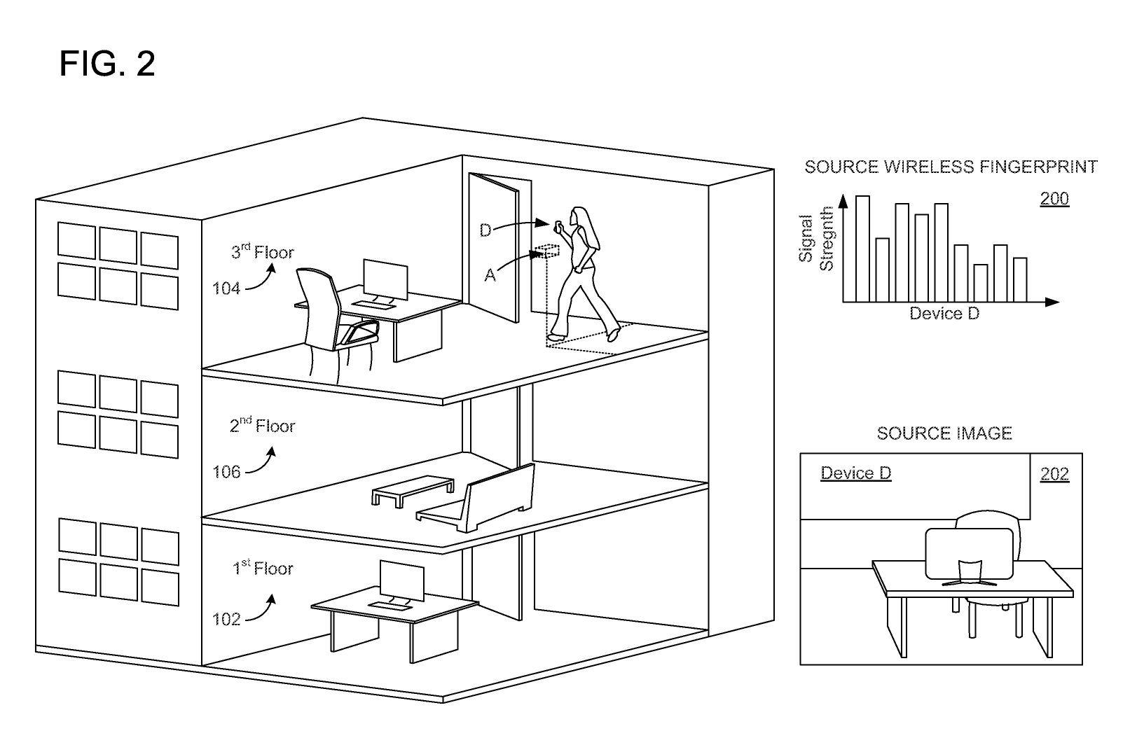

The cataloged locations may be used for device localization when compared to a source wireless fingerprint and a source image captured by a device at or near a location included in the catalog. FIG. 2 shows a source wireless fingerprint 200 and a source image 202 captured by a device D on the 3rd floor 104. Because nearby position A of the 3^{rd} Floor is included in the cataloged locations it is likely that an accurate location of the device may be determined.

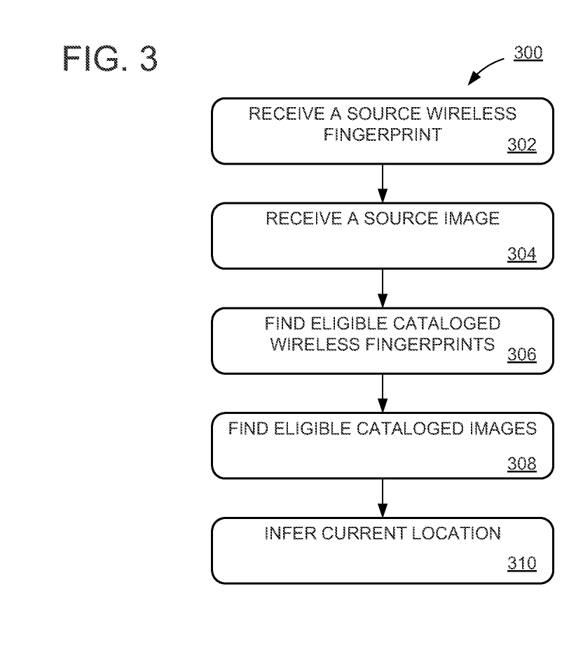

FIG. 3 shows an example method 300 of device localization. Method 300 may be performed by devices that include a camera and a wireless input and/or by separate computing systems that analyze images and wireless fingerprints captured by such devices. At 302, method 300 includes receiving a source wireless fingerprint (such as source wireless fingerprint 200 of FIG. 2) identified by a device at a location. The source wireless fingerprint may include wireless signals from a plurality of wireless access points and may indicate signal strength for each different wireless access point. In some non-limiting examples, the source wireless fingerprint may be characterized as a normalized sparse vector where each wireless access point corresponds with a different dimension of the vector, and the normalized signal strength for each wireless access point is the magnitude for that dimension of the sparse vector.

At 304, method 300 includes receiving a source image (such as source image 202 of FIG. 2). The source image is captured at the same time as the source wireless fingerprint 200. The source image may be a still image or one or more frames from a video image and may be captured by a device carried by a user (as shown in FIG. 2). Further, the source image may be associated with the source wireless fingerprint.

At 306, method 300 includes finding one or more eligible cataloged wireless fingerprints. Cataloged wireless fingerprints may be determined eligible by comparing signal strengths of the source wireless fingerprint with corresponding signal strengths of a cataloged wireless fingerprint.

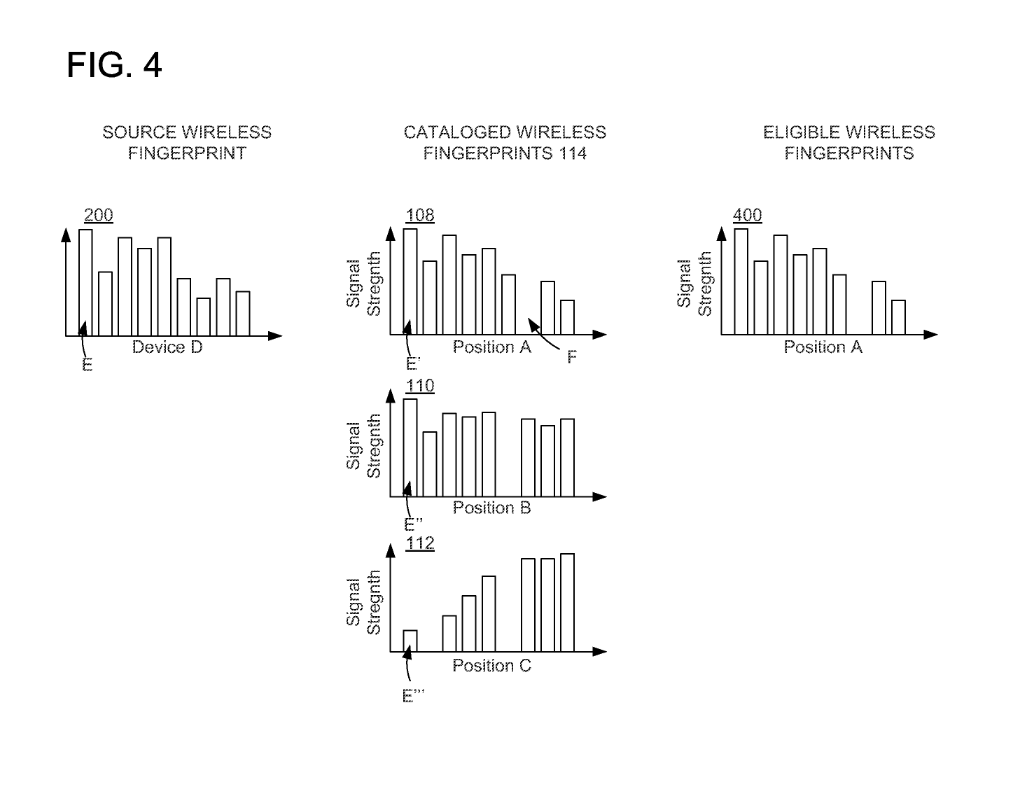

FIG. 4 shows the source wireless fingerprint 200 of FIG. 2 and the cataloged wireless fingerprints 114 of FIG. 1A. In this non-limiting example, the cataloged wireless fingerprint 108 from position A has similar signal strength to the source wireless fingerprint 200 for all of the nine included wireless access points. As such, the cataloged wireless fingerprint from position A is considered an eligible wireless fingerprint 400.

Finding eligible wireless fingerprints may include finding one or more cataloged wireless fingerprints having a threshold similarity to the source wireless fingerprint. The threshold similarity may be defined in any suitable manner. For example, a measured signal strength (such as signal strength E of source wireless fingerprint 200) for each detected wireless access point may be compared to a corresponding cataloged signal strength (such as signal strengths E′, E″, and E′″ of cataloged wireless fingerprints 114) from the cataloged wireless fingerprints. If each measured signal strength is sufficiently similar to each corresponding cataloged signal strength the cataloged wireless fingerprint may be determined eligible. As shown in FIG. 4, cataloged wireless fingerprint 108 from position A is determined to be an eligible wireless fingerprint 400.

In some non-limiting examples, source wireless fingerprints and the cataloged wireless fingerprint may be represented by normalized sparse vectors. For example, source wireless fingerprint 200 may be represented by a normalized sparse vector having a length of one and nine elements representing measured signal strengths for each detected wireless access point. Cataloged wireless fingerprints 114 may be represented by normalized sparse vectors in the same manner.

When both the cataloged wireless fingerprint and the source wireless fingerprint are represented by normalized sparse vectors, the dot product between the two vectors may be a number between zero and one (zero when the two vectors are completely dissimilar and one when the two vectors exactly match). Using the vector dot product, a threshold similarity can be set as a number that rejects combinations of vectors that are not sufficiently matching and accepts combinations of vectors that are sufficiently matching. In some examples, the threshold similarity is set at 0.4. However, any suitable number may be used as a threshold similarity to select eligible wireless fingerprints.

The source wireless fingerprint and an eligible cataloged wireless fingerprint do not have to exactly match for their dot product to meet the threshold similarity. For example, cataloged wireless fingerprint 108 of position A may be determined eligible despite a missing measured signal strength F because all other measured signal strength are sufficiently similar to the cataloged signals strengths.

The examples listed above are intended for illustrative purposes and are not meant to limit the scope of this disclosure in any manner. Further, other suitable methods may be employed to facilitate finding one or more eligible wireless fingerprints.

Returning to FIG. 3, at 308, method 300 includes finding one or more eligible cataloged images. Eligible cataloged images may be found using a variety of image comparison strategies.

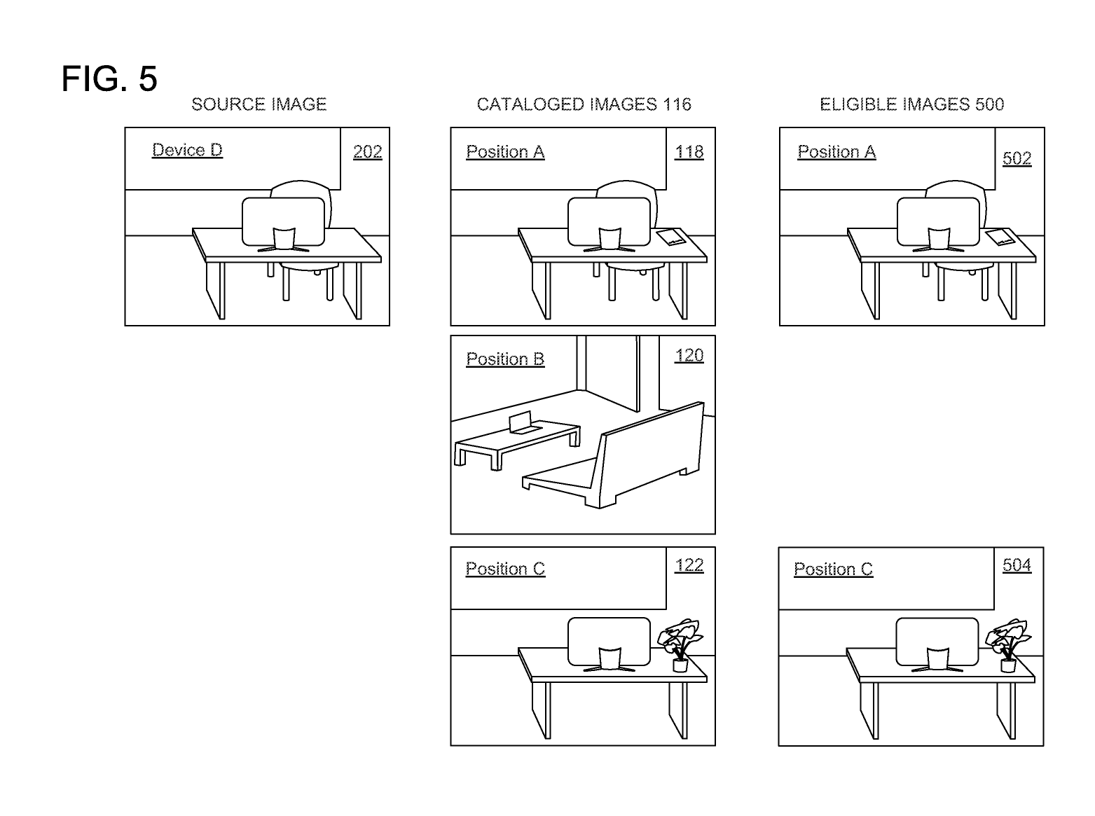

FIG. 5 shows the source image 202 of FIG. 2 and the cataloged images 116 of FIG. 1B. In this non-limiting example, the cataloged image 118 from position A and the cataloged image 122 from position C are similar to the source image 202. As such, cataloged image 118 and cataloged image 122 are considered to be eligible images 500 (shown as eligible image 502 and eligible image 504) and the cataloged location (i.e., position C of the 1st floor 102 and position A of the 3rd floor 104) associated with each may be the actual location of device D of FIG. 2.

In some examples, cataloged images may be determined to be eligible when they have a threshold similarity to the source image. The threshold similarity may be used to reject cataloged images that are not sufficiently similar to the source image by choosing which cataloged image associated with a candidate wireless fingerprint most closely matches the source image.

The cataloged images may be compared to the source image using virtually any image analysis/comparison techniques. Chosen eligible cataloged images may be chosen for having a greatest similarity to the source image as judged by the image analysis/comparison techniques employed.

When considered together, the eligible cataloged wireless fingerprints and the eligible image may be used to infer the current location of a device. As such, at 310, method 300 includes inferring a current location of the device as a chosen cataloged location of a chosen eligible cataloged wireless fingerprint and a chosen eligible cataloged image.

For example, eligible wireless fingerprint 400 of FIG. 4 and eligible image 502 of FIG. 5 are associated with position A on the 3^{rd} floor. However, eligible image 504 of FIG. 5 is associated with position C on the 1^{st} floor. Therefore, the inferred current location of the device is likely the 3^{rd} floor as it is a cataloged location of both an eligible cataloged wireless fingerprint and an eligible cataloged image.

The catalog of locations may be updated using source images and source wireless fingerprints gathered by devices in an environment. For example, the inferred current location may be cataloged as a cataloged location with the source image and the source wireless fingerprint and this newly cataloged information may be used for subsequent testing.

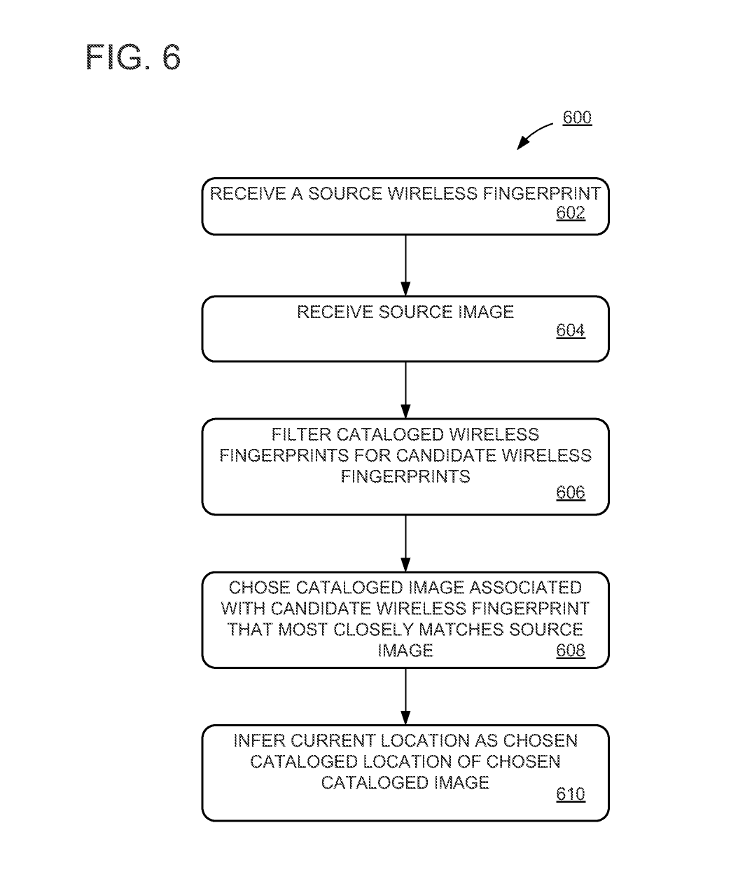

In some examples, finding one or more eligible wireless fingerprints may include filtering one or more cataloged wireless fingerprints for one or more candidate wireless fingerprints. FIG. 6 shows an example method 600 of device localization using filtered candidate wireless fingerprints.

As similarly shown in FIG. 3, at 602, method 600 includes receiving a source wireless fingerprint. Further, at 604, method 600 includes receiving a source image. The methods of receiving a source wireless fingerprint and a source image are similar to those discussed above with regard to FIG. 3.

At 606, method 600 includes filtering cataloged wireless fingerprints for candidate wireless fingerprints. The candidate wireless fingerprint may have a threshold similarity to the source wireless fingerprint and the method of filtering may be similar to any of the above described methods of comparing the source wireless fingerprint to the cataloged wireless fingerprint. Because multiple cataloged wireless fingerprints may have a threshold similarity to the source wireless fingerprint, spurious candidate wireless fingerprints may be eliminated by determining which of the one or more candidate wireless fingerprints has an associated cataloged image most closely matching the source image. Accordingly, at 608 method 600 includes choosing which cataloged image associated with a candidate wireless fingerprint most closely matches the source image.

The chosen cataloged image may be used to infer the current location of the device. As such, at 610, method 600 includes inferring a current location of the device as a chosen cataloged location of a chosen cataloged image.

It should be noted, in some non-limiting examples filtering cataloged images may occur prior to choosing a sufficiently matching wireless fingerprint. Therefore, finding one or more eligible images may include filtering the one or more cataloged images for one or more candidate images. The one or more candidate images may have a threshold similarity to the source image and the method of filtering may include any of the above described methods of image comparison. Because multiple cataloged images may be selected as candidate images, spurious candidate images may be eliminated by determining which of the one or more candidate images has an associated cataloged wireless fingerprint most closely matching the source wireless fingerprint.

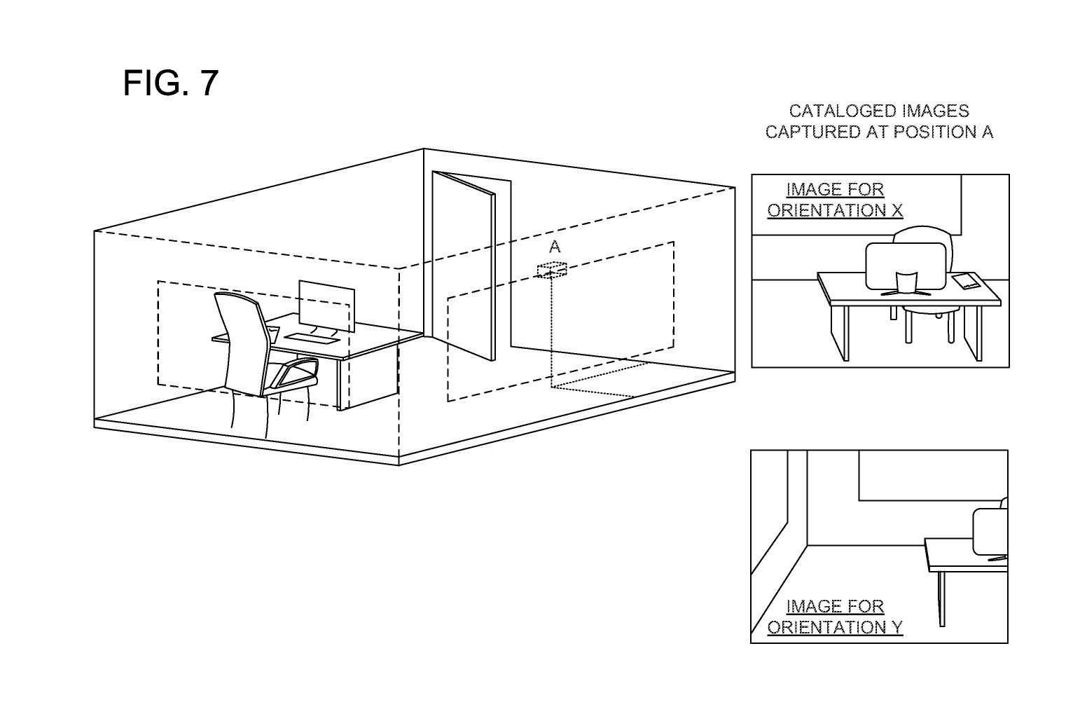

In some examples, each cataloged image may be associated with a cataloged orientation (e.g., yaw, pitch, roll). FIG. 7 shows two differing cataloged images captured at position A that reflect differing orientations (i.e., image for orientation X and image for orientation Y) describing the orientation a device had when each of the two images was captured.

The recorded orientation (e.g., yaw, pitch, roll or another suitable orientation description) may be included in the cataloged locations as cataloged orientations for cataloged images. Further, each cataloged orientation may be associated with a cataloged image that may also be associated with a cataloged wireless fingerprint.

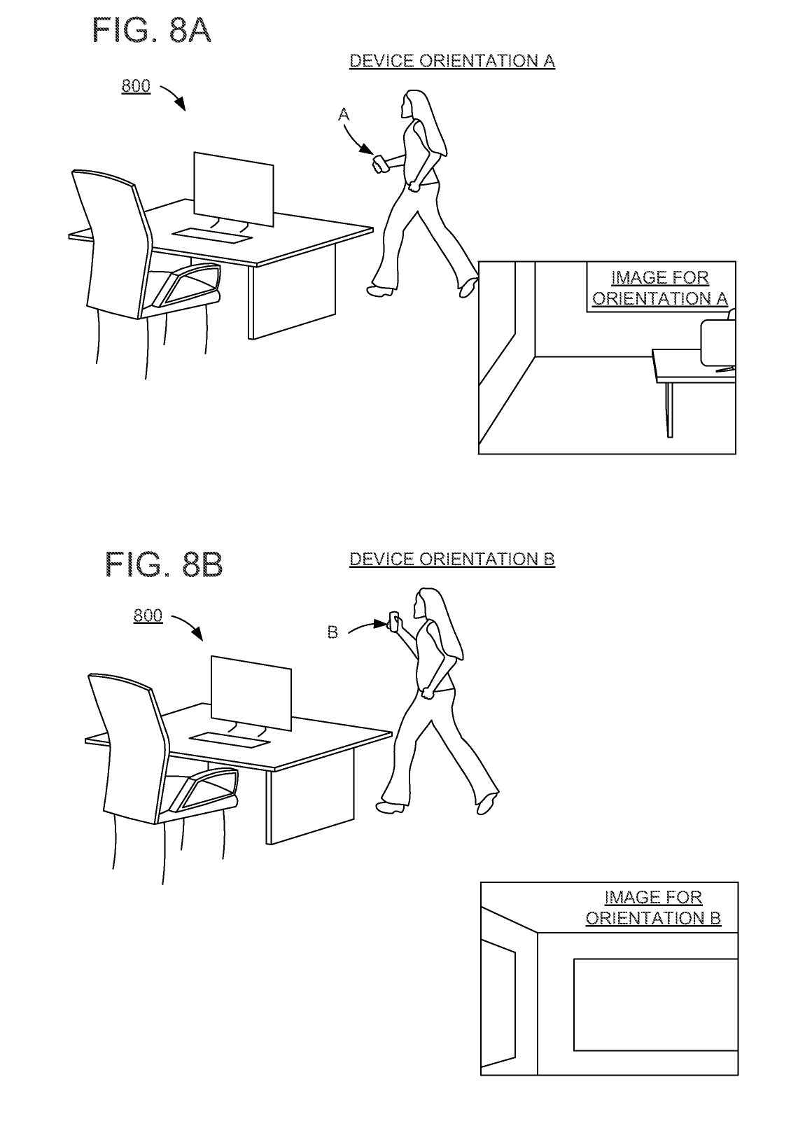

The cataloged orientations may be used to infer a current orientation of a device. FIGS. 8A and 8B show an example environment 800 in which a device may be in a similar location, but in different orientations (e.g., device orientation A and device orientation B). The source image captured by the device may reflect the orientation of the device when the source image was captured (e.g., image for orientation A was captured by the device in orientation A and image for orientation B was captured by the device in orientation B). When compared to the cataloged images captured at position A of FIG. 7, image for orientation A of FIG. 8A matches the image for cataloged orientation Y. Therefore, the current orientation of the device may be inferred as cataloged orientation Y, and the chosen cataloged orientation of the chosen cataloged image may accurately match the source orientation to the cataloged orientation.

When considered together the cataloged location and the cataloged orientation may collectively define a cataloged six-degree-of-freedom pose that may be associated with a cataloged image. The cataloged six-degree-of-freedom pose may include accurate information on x, y, z location, and yaw, pitch, and roll. Therefore, the cataloged six-degree-of-freedom pose may allow for accurate device localization that includes device orientation.

The current orientation and the current location of a device may be used to determine a current six-degree-of-freedom pose of the device. Furthermore, the current orientation and the current location of the device may collectively define a current six-degree-of-freedom pose of the device, and the current six-degree-of-freedom pose of the device may be inferred as a chosen six-degree-of-freedom pose of a chosen cataloged image.

The catalog of locations may be updated using the source image orientation, and the inferred current orientation may be cataloged as a cataloged orientation with the source image and the source wireless fingerprint. Further, the current six-degree-of-freedom pose may also be cataloged as a cataloged six-degree-of-freedom pose associated with the current orientation and the current location.

In some embodiments, the methods and processes described herein may be tied to a computing system of one or more computing devices. In particular, such methods and processes may be implemented as a computer-application program or service, an application-programming interface (API), a library, and/or other computer-program product.

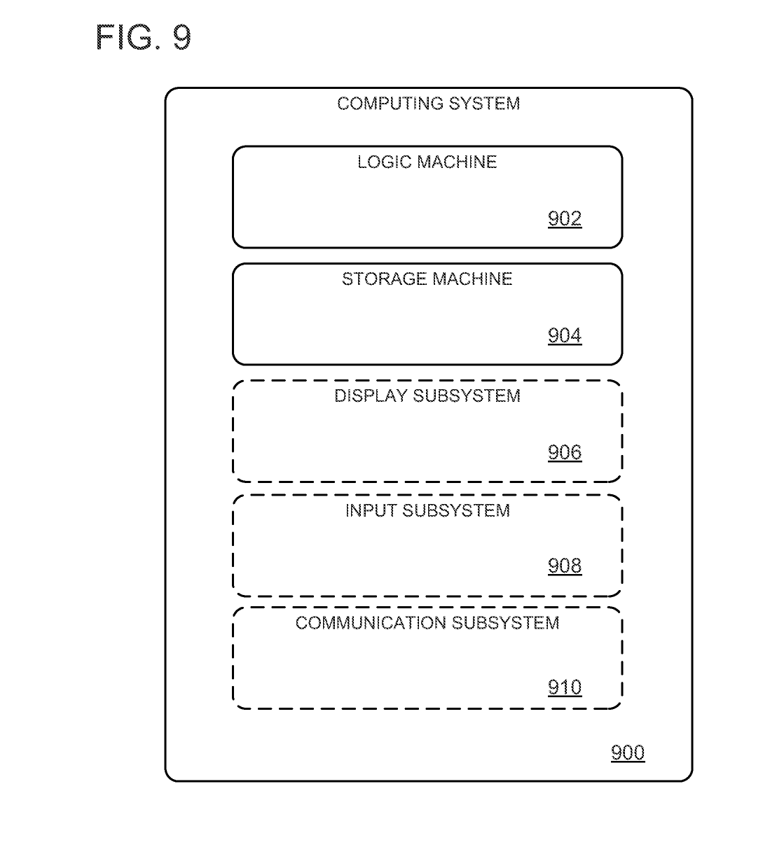

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices. Computing system 900 may be part of a camera used to acquire source images or catalog images and/or a device used to acquire source wireless fingerprints or catalog wireless fingerprints. Alternatively, computing system 900 may be one or more separate devices configured to analyze images and/or wireless fingerprints acquired by other devices.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method of device localization, the method comprising:
receiving a source wireless fingerprint identified by a device at a location;
receiving a source image associated with the source wireless fingerprint, the source image captured by the device at the location;
finding one or more eligible cataloged wireless fingerprints having a threshold similarity to the source wireless fingerprint, each cataloged wireless fingerprint associated with a cataloged location and a cataloged image;
finding one or more eligible cataloged images having a threshold similarity to the source image, each cataloged image associated with a cataloged location and a cataloged wireless fingerprint; and
inferring a current location of the device as a chosen cataloged location of a chosen eligible cataloged wireless fingerprint and a chosen eligible cataloged image.

2. The method of claim 1, wherein each cataloged image is associated with a cataloged orientation, and further comprising inferring a current orientation of the device as a chosen cataloged orientation of the chosen eligible cataloged image.

3. The method of claim 2, further comprising cataloging the inferred current orientation as a cataloged orientation with the source image and the source wireless fingerprint.

4. The method of claim 2, wherein the current orientation and the current location collectively define a six-degree-of-freedom pose of the device.

5. The method of claim 1, wherein the source wireless fingerprint indicates signal strength for each of a plurality of different wireless access points.

6. The method of claim 5, wherein finding one or more eligible wireless fingerprints having a threshold similarity to the source wireless fingerprint includes comparing signal strengths of the source wireless fingerprint with corresponding signal strengths of a cataloged wireless fingerprint.

7. The method of claim 1, wherein finding one or more eligible wireless fingerprints includes filtering the one or more cataloged wireless fingerprints for one or more candidate wireless fingerprints having a threshold similarity to the source wireless fingerprint, and finding one or more eligible images includes determining which of the one or more candidate wireless fingerprints has an associated cataloged image most closely matching the source image.

8. The method of claim 1, wherein finding one or more eligible images includes filtering the one or more cataloged images for one or more candidate images having a threshold similarity to the source image, and finding one or more eligible wireless fingerprints includes determining which of the one or more candidate images has an associated cataloged wireless fingerprint most closely matching the source wireless fingerprint.

9. The method of claim 1, further comprising cataloging the inferred current location as a cataloged location with the source image and the source wireless fingerprint.

10. The method of claim 1, wherein the device includes a camera and a wireless input.

11. The method of claim 1, wherein the source image is a still image.

12. The method of claim 1, wherein the source image is a video image.

13. The method of claim 1, wherein the chosen eligible cataloged image is chosen for having a greatest similarity to the source image.

14. On a computing device, a method of device localization, the method comprising:
receiving a source wireless fingerprint identified by a device at a location;
receiving a source image associated with the source wireless fingerprint, the source image captured by the device at the location;
filtering one or more cataloged wireless fingerprints for one or more candidate wireless fingerprints having a threshold similarity to the source wireless fingerprint, each cataloged wireless fingerprint associated with a cataloged location and a cataloged image;
choosing which cataloged image associated with a candidate wireless fingerprint most closely matches the source image; and
inferring a current location of the device as a chosen cataloged location of a chosen cataloged image.

15. The method of claim 14, wherein each cataloged image is associated with a cataloged orientation, and further comprising inferring a current orientation of the device as a chosen cataloged orientation of the chosen cataloged image.

16. The method of claim 15, wherein the current orientation and the current location collectively define a six degree of freedom pose of the device.

17. The method of claim 14, wherein the source wireless fingerprint indicates signal strength for each of a plurality of different wireless access points.

18. The method of claim 14, wherein the device includes a camera and a wireless input.

19. The method of claim 14, further comprising cataloging the inferred current location as a cataloged location with the source image and the source wireless fingerprint.

20. A computing system configured for device localization, the system comprising:
a logic machine;
a storage machine holding instructions executable by the logic machine to:
receive a source wireless fingerprint identified by a device at a location;
receive a source image associated with the source wireless fingerprint, the source image captured by the device at the location and being associated with a six-degree-of-freedom pose;
filter one or more cataloged wireless fingerprints for one or more candidate wireless fingerprints having a threshold similarity to the source wireless fingerprint, each cataloged wireless fingerprint associated with a cataloged location and a cataloged image;
choose which cataloged image associated with a candidate wireless fingerprint most closely matches the source image; and
infer a current six-degree-of-freedom pose of the device as a chosen six-degree-of-freedom pose of a chosen cataloged image.
